(19) United States
(12) Patent Application Publication
(10) Pub. No.: US 2006/0068171 A1
(43) Pub. Date: Mar. 30, 2006

(54) Light diffusing plate

(75) Inventors: Tomohiro Maekawa, Niihama-shi (JP); Akiyoshi Kanemitsu, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/232,977

(22) Filed: Sep. 23, 2005

(30) Foreign Application Priority Data
Sep. 27, 2004 (JP) 2004-278832

(51) Int. Cl. B32B 3/20

(52) U.S. Cl. 428/188

(57) ABSTRACT

A light diffusing plate having a plurality of hollow portions formed therein is provided. The hollow portions extend in parallel with one another in the light diffusing plate. Since the hollow portions are formed inside the plate, a weight of the plate can be effectively reduced.

### BACKGROUND OF THE INVENTION

1. Field of the Invention

The present invention relates to a light diffusing plate.

2. Description of the Related Art

A light diffusing plate is a plate having the function of allowing incident light to transmit therethrough while the incident light is diffused in the plate. The light diffusing plate is widely used for the following purpose: the light diffusing plate is arranged on the back side of an image displaying element constituting a flat panel display device, and allows incident light to transmit therethrough while the incident light is uniformly diffused in the plate to emit diffuse transmission light toward a front face of the flat panel display device. As such a light diffusing plate, there has been known one having a solid structure which is obtained by molding into a plate shape a light-diffusive resin composition obtained by dispersing a light diffusing agent in a resin, and which has no space (hollow) inside thereof (see, for example, Japanese Patent Application Laid-Open Nos. 59-68333 and 60-13813). In these days, a size of the flat panel display device is increased, which demands weight reduction of the light diffusing plate in order to have easy handling with maintaining the mechanical strength of the plate.

### SUMMARY OF THE INVENTION

One of objects of the present invention is to provide a light diffusing plate which can be easily handled even if the plate has a large size, with its weight reduced. The present inventors have eagerly studied to develop such a light diffusing plate, resulting in the present invention.

The present invention provides a light diffusing plate having a plurality of hollow portions formed therein, the hollow portions extending in parallel with one another.

### BRIEF DESCRIPTION OF THE DRAWINGS

FIGS. 1A and 1B are sectional views each schematically showing an example of a light diffusing plate according to the present invention;

FIG. 2 is a perspective view showing an example of the light diffusing plate according to the present invention;

FIG. 3 is a sectional view schematically showing a preferred example of the light diffusing plate according to the present invention; and

FIG. 4 is a sectional view schematically showing an example of a flat panel display device in which the light diffusing plate according to the present invention is used.

### DESCRIPTION OF THE PREFERRED EMBODIMENTS

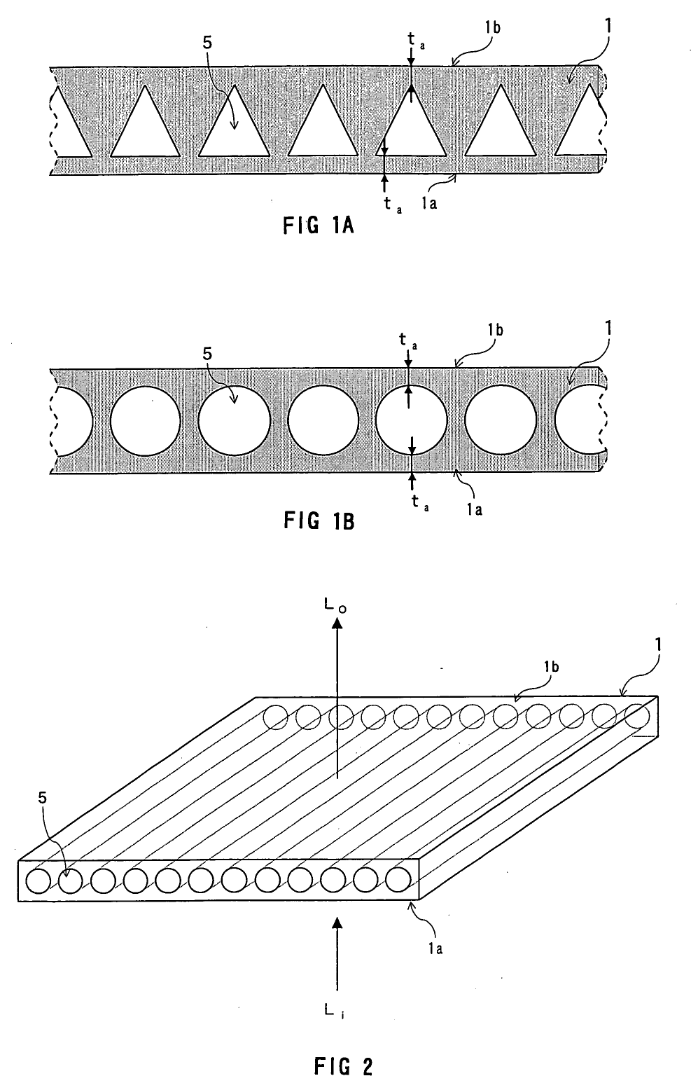

As shown in FIGS. 1A and 1B, a light diffusing plate (1) according to the present invention has a plurality of hollow portions (5) formed so that the hollow portions extends in parallel with one of the sides of the plate. The plurality of hollow portions (5) are formed independently from one another with an equivalent distance and extending over the entirety of the light diffusing plate (1).

Examples of a sectional shape of the hollow portion (5) include a triangular shape (FIG. 1A), a circular shape (FIG. 1B) and the like.

A ratio of the total sum (S₅) of sectional areas of the hollow portions (5) to the total sectional area (S₁) of the light diffusing plate (1) including the hollow portion areas, i.e., [S₅/S₁×100(%)], may be in the range of from 5% to 75%, is preferably in the range of from 10% to 67%, and is more preferably in the range of from 15% to 67%. When the ratio is excessively high, it may be disadvantageous in view of strength. In contrast, when the ratio is too low, it may be disadvantageous in handling in view of, for example, weight reduction.

Here, the sectional areas are obtained by cutting the light diffusing plate along with the direction of the thickness. The sectional shapes of the hollow portions (5), perpendicular to the extending longer direction of the hollow portions, may be different or the same among the hollow portions, and are appropriately selected depending on the arrangement of light sources in a backlight system to which the light diffusing plate is applied.

A thickness (t₁) of the light diffusing plate (1) according to the present invention may be in the range of 1 mm or more, preferably in the range of 1.5 mm or more in view of easiness in forming rib members (4), while may be in the range of 10 mm or less, preferably in the range of 5 mm or less, more preferably in the range of 3.5 mm or less in view of easiness in assembling the resulting plate into a back face side of a flat panel display device (6).

It is preferred that a minimum distance (tₐ) between the hollow portion (5) and a main face (1a) of the light diffusing plate is in the range of from about 0.1 mm to about 1 mm, in view of strength. The minimum distance (tₐ) is preferably constant along the longer direction of the hollow. It is also preferred that a distance between the hollow portions (5) adjacent to each other, i.e., the minimum distance of the distance is in the range of 0.1 mm and more in view of strength and is in the range of 1 mm or less in view of weight reduction.

An area of the light diffusing plate (1) according to the present invention is not particularly limited. From the viewpoint of exerting effects of weight reduction, the area is preferably 20 cm×30 cm or more, and also 150 cm×200 cm or less.

FIG. 2 is a perspective view showing an example of the light diffusing plate (1) according to the present invention wherein a sectional shape of the hollow portion (5) is circular as shown in FIG. 1B. The hollow portions (5) are arranged in parallel with the main faces (1a, 1b) and they extend inside the light diffusing plate (1) wherein the hollow portions (5) are parallel to one another.

In the light diffusing plate (1) of the present invention, an incident light (Lᵢ) is allowed to input through one (1a) of the main faces. The incident light (Lᵢ) thus input transmits the light diffusing plate (1) while being diffused inside thereof, and outputs from the other main face (1b) as a diffusion transmitted light (Lₒ).

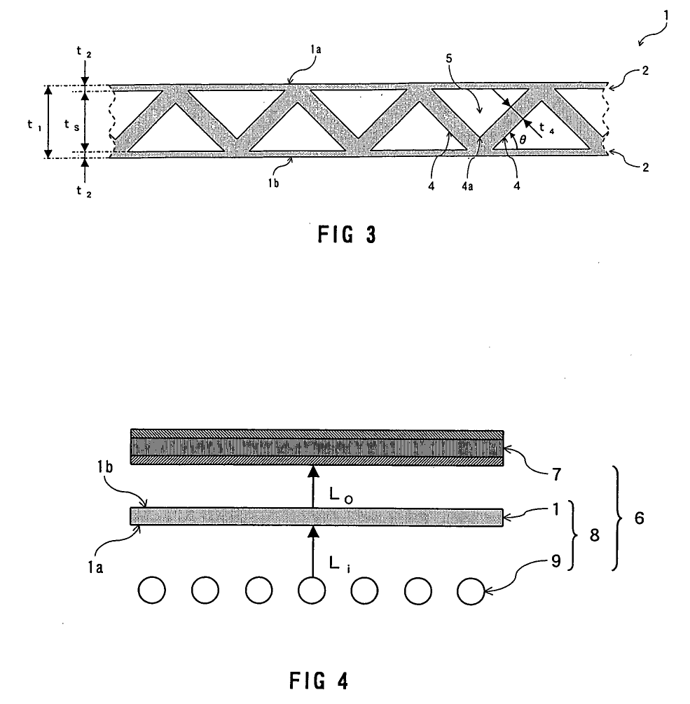

The preferable structure of the light diffusing plate (1) of the present invention has the hollow portions (5) with the same triangle sectional shapes, the triangle sectional shapes being alternately placed upside down as shown in FIG. 3.

In FIG. 3, the light diffusing plate (1) has a structure wherein a plurality of rib members (4) are arranged between a pair of flat plates (2, 2).

As shown in the sectional view of FIG. 3, the pair of flat plates (2, 2) are arranged with a spacing (tₛ) therebetween. Each thickness (t₂) of the flat plates (2, 2) may be in the arrange of from about 0.1 mm to 1 mm, and the spacing (tₛ) between the flat plates (2, 2) may be in the arrange of from about 0.5 mm to about 5 mm.

A thickness (t₄) of the plurality of rib members (4) arranged between the flat plates (2, 2) is preferably almost constant at any position so as to be in the range of from about 0.1 mm to about 1 mm, and the plurality of rib members (4) extend in parallel with one another.

The rib member (4) is preferably placed at an angle (θ) of from 30° to 75° with respect to the flat plate (2). When the angle (θ) is less than 30°, strength of the light diffusing plate (1) tends to be insufficient, while when it exceeds 75°, it may be difficult to diffuse uniformly a light from the light source due to the rib members (4).

The rib member (4) makes contact with the adjacent rib member (4) on or in the vicinity of a line (4a) at which the rib members make contact with the flat plate (2), whereby a triangular hollow portion (5) in its section is formed by the flat plate (2) and the adjacent rib members.

The light diffusing plate (1) shown in FIG. 3 has a construction such that a rib member (4) is placed at an angle (θ) of 30° to 75° with respect to a flat plate (2), and the adjacent rib members (4) are in contact with one another at the line (4a) at which the rib members (4) are in contact with the flat plate (2). Therefore, an incident light (Lᵢ) input through the surface (1a) of the light diffusing plate from a light source can be allowed to transmit the light diffusing plate (1), while diffusing uniformly and evenly the light. Furthermore, the light diffusing plate (1) in FIG. 3 also has a construction such that the rib members (4) are arranged between a pair of flat plates (2, 2), and these rib members (4) extend interchangeably in parallel with one another, so that when the light diffusing plate (1) is made from a resin, no or little camber (wrap) appears even if the resin gets moist.

A thickness (t₁) of the light diffusing plate (1) of the present invention may be 1 mm or more, and is preferably 1.5 mm or more in view of forming easily the rib members (4) and the like, while it may be 10 mm or less, preferably 5 mm or less, and is more preferably 3.5 mm or less in view of setting easily the light diffusing plate in the backside of the flat panel display device (6).

In the light diffusing plate (1), the hollow portions (5) are formed from top plates (2, 2) and the rib members (4) adjacent to one another. When a total of sectional area of the hollow portions (5) is excessively large, it is disadvantageous from the viewpoint of strength, while when the total of hollow sectional area is remarkably small, it is disadvantageous from the viewpoint of weight reduction. Accordingly, as described above, a ratio of the total sum (S₅) of sectional areas of the hollow portions (5) to the total sectional area (S₁) of the light diffusing plate (1) including the hollow portion areas, i.e., [S₅/S₁×100(%)] may be in the range of from 5% to 75%, preferably in the range of from 10% to 67%, more preferably in the range of from 15% to 67%. This means that the proportion [S₅:S₂₄] of the total sectional area (S₅) of the hollow portions (5) with respect to the total sectional area (S₂₄) of the top plates (2) and the rib members (4) may be in the range from 1:20 to 3:1, preferably in the range from 1:10 to 2:1, and is more preferably in the range from 1:7 to 2:1.

The light diffusing plate (1) of the present invention has the function of allowing incident light to transmit therethrough, while the incident light is diffused in the plate (1).

The light diffusing plate (1) may comprises a resin such as general-purpose plastics or engineering plastics. Examples of such general-purpose plastics or engineering plastics include polyvinyl chloride resin, acrylonitrile-butadiene-styrene resin, low-density polyethylene resin, high-density polyethylene resin, straight-chain low-density polyethylene resin, polystyrene resin, polypropylene resin, acrylonitrile-styrene resin, cellulose acetate resin, ethylene-vinyl acetate resin, acrylate-acrylonitrile-styrene resin, acrylate-chlorinated polyethylene resin, ethylene-vinyl alcohol resin, fluororesin, methyl methacrylate resin, methyl methacrylate-styrene resin, polyacetal resin, polyamide resin, polyethylene terephthalate resin, aromatic polycarbonate resin, polysulfone resin, polyether sulfone resin, methylpentene resin, polyarylate resin, polybutylene terephthalate resin, resins containing alicyclic structure-containing ethylenically unsaturated monomeric unit, polyphenylene sulfide resin, polyphenylene oxide resin, and polyether ether ketone resin.

Furthermore, elastomers may be used and examples thereof include polyvinyl chloride elastomer, chlorinated polyethylene, ethylene-ethyl acrylate resin, thermoplastic polyurethane elastomer, thermoplastic polyester elastomer, ionomer resin, styrene-butadiene block copolymer, ethylene-propylene rubber, polybutadiene resin, and acrylic elastomer. These resins may be used alone or in combinations of two or more of them.

Resins having good optical characteristics are preferred, and examples thereof include methyl methacrylate resin, polystyrene resin, methyl methacrylate-styrene resin, aromatic polycarbonate resin, a resin containing an alicyclic structure-containing ethylenically unsaturated monomeric unit, and polyethylene terephthalate resin. More preferred examples of the resins include methyl methacrylate resin, styrene resin, methyl methacrylate-styrene resin, aromatic polycarbonate resin, and a resin containing an alicyclic structure-containing ethylenically unsaturated monomeric unit.

The methyl methacrylate resin is a resin composed of methyl methacrylate-based polymer containing methyl methacrylate units as its monomeric unit in which an amount of the methyl methacrylate units may be 50% by weight or more, and is preferably 80% by weight or more. The methyl methacrylate-based polymer may be a homopolymer composed of 100% by weight of methyl methacrylate units. Such a polymer having 100% by weight of methyl methacrylate units is a methyl methacrylate homopolymer obtainable by polymerizing methyl methacrylate alone.

Moreover, the methyl methacrylate-based polymer may be a copolymer obtainable by copolymerizing methyl methacrylate with a monomer copolymerizable therewith.

Examples of the monomers copolymerizable with methyl methacrylate include methacrylate esters other than methyl methacrylate. Specific examples of the methacryl esters include ethyl methacrylate, butyl methacrylate, cyclohexyl methacrylate, phenyl methacrylate, benzyl methacrylate, 2-ethylhexiyl methacrylate, 2-hydroxyethyl methacrylate, and the like. Furthermore, examples of the copolymerizable monomer include acrylatic esters such as methyl acrylate, ethyl acrylate, butyl acrylate, cyclohexyl acrylate, phenyl acrylate, benzyl acrylate, 2-ethylhexyl acrylate, and 2-hydroxyethyl acrylate; unsaturated acids such as methacrylic acid, and acrylic acid; halogenated styrenes such as chlorostyrene, and bromostyrene; substituted styrenes such as alkylstyrenes, e.g., vinyltoluene, and α-methylstyrene; acrylonitrile, methacylonitrile, maleic anhydride, phenylmaleimide, cyclohexylmaleimide, and the like. These monomers may be used alone or in combinations of two or more of them.

The polystyrene resin is a polymer containing a styrene-based monofunctional monomeric unit as its monomeric unit in which an amount of the units may be 50% by weight or more. The polymer may be a homopolymer of a styrene-based monofunctional monomer or a copolymer of a styrene-based monofunctional monomer and a monofunctional monomer copolymerizable therewith.

The styrene-based monofunctional monomer includes a compound having a styrene skeleton and containd one double bond polymerizable radically in its molecule, such as halogenated styrenes, e.g, chlorostyrene, and bromostyrene; and substituted styrenes such as alkylstyrenes, e.g., vinyltoluene and α-methylstyrene.

The monofunctional monomer copolymerizable with a styrene-based monofunctional monomer includes a compound containing one double bond radically polymerizable with a styrene-based monofunctional monomer in its molecule. Examples of the monofunctional monomer include methacrylic esters such as methyl methacrylate, ethyl methacrylate, butyl methacrylate, cyclohexyl methacrylate, phenyl methacrylate, benzyl methacrylate, 2-ethylhexyl methacrylate, and 2-hydroxyethyl methacrylate; acrylate esters such as methyl acrylate, ethyl acrylate, butyl acrylate, cyclohexyl acrylate, phenyl acrylate, benzyl acrylate, 2-ethylhexyl acrylate, and 2-hydroxyethyl acrylate; acrylonitrile, and the like. Among them, methacrylic esters such as methyl methacrylate are preferably used. They may be used alone or in combinations of two or more of them.

The aromatic polycarbonate resin includes a polymer obtainable by polymerizing a carbonate prepolymer through a solid-phase ester-exchange method, and a polymer obtainable by ring-opening polymerization of a cyclic carbonate compound, in addition to a polymer obtainable by reacting a divalent phenol with a carbonate precursor through an interfacial polycondensating method or a fusion ester exchanging method.

Typical examples of the above-mentioned divalent phenol include hydroquinone, resorcinol, 4,4′-dihydroxydiphenyl, bis(4-hydroxyphenyl)methane, bis{(4-hydroxy-3,5-dimethyl)phenyl}methane, 1,1-bis(4-hydroxyphenyl)ethane, 1,1-bis(4-hydroxyphenyl)-1-phenylethane, 2,2-bis(4-hydroxyphenyl)propane (common name: bisphenol A), 2,2-bis{(4-hydroxy-3-methyl)phenyl}propane, 2,2-bis{(4-hydroxy-3,5-dimethyl)phenyl}propane, 2,2-bis{(4-hydroxy-3,5-dibromo)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α′-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxydiphenylsulfone, 4,4′-dihydroxydiphenylsulfoxide, 4,4′-dihydroxydiphenylsulfide, 4,4′-dihydroxydiphenylketone, 4,4′-dihydroxydiphenylether, and 4,4′-dihydroxydiphenylester. They may be used alone or in combinations of two or more of them.

Among them, homopolymers and copolymers obtained from at least one bisphenol selected from the group consisting of bisphenol A, 2,2-bis{(4-hydroxy-3-methyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylhexane, and α,α′-bis(4-hydroxyphenyl)-m-diisopropylbenzene are preferred, and particularly, homopolymers of bisphenol A, and copolymers prepared from 1,1-bis(4-hydroxyphenyl)-3,3,5-trimethylcyclohexane with at least one divalent phenol selected from bisphenol A, 2,2-bis{(4-hydroxy-3-methyl)phenyl}propane, and α,α′-bis(4-hydroxyphenyl)-m-diisopropylbenzene are preferably used.

The above-mentioned polycarbonate precursores include carbonyl halides, carbonate esters or haloformates and the like. Specific examples thereof include phosgene, diphenylcarbonates or dihaloformates of a divalent phenol, and the like.

Examples of the above-mentioned resins containing an alicyclic structure-containing ethylenically unsaturated monomeric unit include norbornene-based polymers, vinyl alicyclic hydrocarbon-based polymers and the like.

The resins containing an alicyclic structure-containing ethylenically unsaturated monomeric unit are characterized by containing an alicyclic structure in a repeating unit of the polymer resin wherein the alicyclic structure may be in either a principal chain and/or a side chain, but it is preferred to contain the alicyclic structure in the principal chain in view of optical transparency.

Examples of the polymer resins containing such alicyclic structure include norbornene-based polymers, monocyclic cycloolefin-based polymers, cyclic conjugated diene-based polymers, vinyl alicyclic hydrocarbon-based polymers and the hydrogenated products thereof. Among them, preferred are hydrogenated norbornene-based polymers, vinyl alicyclic hydrocarbon-based polymers or hydrogenated products thereof and the like; and hydrogenated products of norbornene-based polymers are more preferable in view of optical transparency.

In the light diffusing plate (1) according to the present invention, an incident light can be diffused due to the difference in refractive index between the resin of the flat plates and the hollow portions (air). The light diffusing plate (1) is preferably made from a resin into which a light diffusing agent is dispersed. By the use of light diffusing agent, a light can be diffused by the light diffusing agent in the resulting light diffusing plate (which is internal diffusion), or by fine unevenness (concavities and convexities) formed by the light diffusing agent on a surface of the light diffusing plate (which is external diffusion). In the case of internal diffusion, inorganic or organic fine particles having a different refractive index from that of the resin (into which the particles are to be dispersed) are used as the light diffusing agent. Specifically, it is preferred that the inorganic or organic fine particles used in internal diffusion has an absolute value in a difference of refractive index from that of the resin is within a range of from 0.02 to 0.13. On the other hand, in the case of external diffusion, inorganic or organic fine particles having a different or the same refractive index from or with that of the resin (into which the particles are to be dispersed) may be used as the light diffusing agent.

Examples of the inorganic fine particles include calcium carbonate particles, barium sulfate particles, titanium oxide particles, aluminum hydroxide particles, silica particles, glass particles, talc particles, mica particles, white carbon particles, magnesium oxide particles, and zinc oxide particles. These particles may be surface-treated with a surface treating agent such as fatty acids.

Examples of the organic fine particles include crosslinked resin particles such as crosslinked styrene-based resin particles, crosslinked acryl-based resin particles, and crosslinked siloxane-based resin particles; high-molecular weight resin particles having a high molecular weight such as high-molecular weight styrene-based resin particles, high-molecular weight acryl-based resin particles and the like. The crosslinked resin particles are particles having a gel fraction of about 10% or more in the case that the resin particles are dissolved in acetone, while the high-molecular weight resin particles are particles having a weight-average molecular weight (Mw) of 500,000 to 5,000,000.

The refractive indexes of the styrene-based polymer resin, acryl-based polymer resin and crosslinked siloxane-based polymer resin in the organic fine particles vary depending upon types, compositions and the like of the monomers constituting the polymer resins, and are in the range of from about 1.53 to about 1.61, in the range of from about 1.46 to about 1.55 and in the range of from about 1.40 to 1.47, respectively. The styrene-based polymer resin and acryl-based polymer resin tend to have higher refractive indexes as the larger amount of the monomers containing phenyl groups or the larger amount of halogenated monomers are used to prepare the resins. The crosslinked siloxane-based polymer resin also tends to have higher refractive indexes as the siloxane-based polymer has the larger amount of phenyl groups or the larger amount of organic groups combined directly with silicon atom therein. In internal diffusion, these polymer resins are appropriately selected so as to have an appropriate difference in refractive index with respect to that of a resin into which the particles of the polymer resins are to be dispersed as light diffusing agents.

Examples of the styrene-based resin particles as the organic fine particles include:

(1) high-molecular weight resin particles obtained by polymerizing styrene-based monomers, or high-molecular weight resin particles obtained by polymerizing a monomer containing 50% by weight or more of styrene-based monomeric unit and having one double bond polymerizable radically in its molecule; and

(2) crosslinked resin particles obtained by polymerizing a monomer having at least two double bonds polymerizable radically with a styrene-based monomer in its molecule, or crosslinked resin particles obtained by polymerizing a monomer containing 50% by weight or more of a styrene-based monomeric unit and having one double bond polymerizable radically in its molecule with a monomer containing at least two double bonds polymerizable radically in its molecule.

Specific examples of the styrene-based monomers as the organic fine particles include styrene, and the derivatives thereof. Examples of the styrene derivatives include halogenated styrenes such as chlorostyrene, and bromostyrene; and alkyl-substituted styrenes such as vinyltoluene, and α-methylstyrene. It is, however, to be noted that the present invention is not limited to these styrene-based monomers. These styrene-based monomers may be used alone or in combinations of two or more of them.

The monomers containing one double bond polymerizable radically in its molecule are not particularly restricted so far as they are the ones other than the above-described styrene-based monomer components, and examples thereof include methacrylate esters such as methyl methacrylate, ethyl methacrylate, butyl methacrylate, cyclohexyl methacrylate, phenyl methacrylate, benzyl methacrylate, 2-ethylhexyl methacrylate, and 2-hydroxyethyl methacrylate; acrylate esters such as methyl acrylate, ethyl acrylate, butyl acrylate, cyclohexyl acrylate, phenyl acrylate, benzyl acrylate, 2-ethylhexyl acrylate, and 2-hydroxyethyl acrylate; and acrylonitrile. Among them, alkylmethacrylates such as methyl methacrylate are preferable. These monomers may be used alone or in combinations of two or more of them.

Monomers each containing at least two double bonds polymerizable radically in its molecule are those copolymerizable with the above-mentioned monomers and except for conjugated dienes. Specific examples of such monomers include alkyldioldi(meth)acrylates such as 1,4-butanedioldi(meth)acrylate, and neopentylglycoldi(meth)acrylate; alkyleneglycoldi(meth)acrylates such as ethyleneglycoldi(meth)acrylate, diethyleneglycoldi(meth)acrylate, tetraethyleneglycoldi(meth)acrylate, propyleneglycoldi(meth)acrylate, and tetrapropyleneglycoldi(meth)acrylate; aromatic polyfunctional compounds such as divinylbenzene, and diallyl phthalate; and (meth)acrylates of polyhydric alcohols such as trimethylolpropane tri(meth)acrylate, and pentaerythritol tetra(meth)acrylate. These monomers may be used alone or in combinations of two or more of them. The expression “(meth)acrylate” means “methacrylate” and “acrylate”.

Examples of the acryl-based resin particles as the organic fine particles include:

(1) high-molecular weight resin particles obtained by polymerizing acryl-based monomers, or high-molecular weight resin particles obtained by polymerizing a monomer containing 50% by weight or more of acryl-based monomeric unit and having one double bond polymerizable radically in its molecule; and

(2) crosslinked resin particles obtained by polymerizing a monomer having at least two double bonds polymerizable radically with an acryl-based monomer in its molecule, or crosslinked resin particles obtained by polymerizing a monomer containing 50% by weight or more of an acryl-based monomeric unit and having one double bond polymerizable radically in its molecule with a monomer containing at least two double bonds polymerizable radically in its molecule.

Specific examples of the acryl-based monomers include methyl methacrylate, ethyl methacrylate, butyl methacrylate, cyclohexyl methacrylate, phenyl methacrylate, benzyl methacrylate, 2-ethylhexyl methacrylate, 2-hydroxyethyl methacrylate, methyl acrylate, ethyl acrylate, butyl acrylate, cyclohexyl acrylate, phenyl acrylate, benzyl acrylate, 2-ethylhexyl acrylate, 2-hydroxyethyl acrylate, methacrylic acid, and acrylic acid. These acryl-based monomers may be used alone or in combinations of two or more of them.

Although the monomers each containing one double bond polymerizable radically in its molecule are not particularly limited so far as they are those other than the above-described acryl-based monomers, and examples thereof include styrene and the derivatives thereof. Examples of the styrene derivatives include halogenated styrenes such as chlorostyrene, and bromostyrene; alkyl-substituted styrenes such as vinyltoluene, and α-methyl styrene; and the like. Among them, styrene is preferable. Such monomers may be used alone or in combinations of two or more of them.

Monomers each containing at least two double bonds polymerizable radically in its molecule are those copolymerizable with the above-described monomers and except for conjugated dienes, and may be selected from the above-mentioned monomers.

The styrene-based resin particles and acryl-based resin particles can be manufactured by polymerizing a monomer corresponding thereto in accordance with common polymerization methods such as suspension polymerization, microsuspension polymerization, emulsion polymerization, and dispersion polymerization methods.

The crosslinked siloxane-based resins as the organic fine particles may be those called generally by the name of silicone rubber or silicone resin, and they are in a solid state at ordinary temperatures. The siloxane-based polymers can be manufactured by hydrolysis and condensation of chlorosilane. For instance, the (crosslinked) siloxane-based polymers can be obtained by the method in which chlorosilanes (such as dimethyldichlorosilane, diphenyldichlorosilane, phenylmethyldichlorosilane, methyltrichlorosilane and phenyltrichlorosilane) are hydrolyzed and condensed. Moreover, the crosslinked siloxane-based resins may also be obtained by a method of crosslinking each of these (crosslinked) siloxane-based polymers by a peroxide (such as benzoyl peroxide, 2,4-dichlorobenzoyl peroxide, p-chlorobenzoyl peroxide, dicumyl peroxide, di-t-butyl peroxide and 2,5-dimethyl-2,5-di(t-butylperoxy)hexane); or a method of introducing a silanol group into a terminal of a polysiloxane compound and allowing the resulting polysiloxane compound to condense and crosslink together with alkoxysilanes. Among them, crosslinked siloxane-based polymers having two or three organic groups per a silicon atom are preferable.

The crosslinked siloxane-based resin can be made into a particulate state by a method of pulverizing mechanically the crosslinked siloxane-based resin; a method in which a hardening polymer or a hardening polymer composition containing a specified linear organosiloxane block is cured in an atomized condition (as described in Japanese Patent Application Laid-Open No. 59-68333); a method in which a specified alkyltrialkoxysilane or its partially hydrolyzed condensate is subjected to hydrolysis-condensation in an aqueous solution of ammonia or amines (as described in Japanese Patent Application Laid-Open No. 60-13813; and the like.

A particle diameter of the light diffusing agent may be in the range of from 0.5 μm to 50 μm, and is preferably in the range of from 1 μm to 30 μm.

Into a raw material resin from which the light diffusing plate is manufactured, a variety of additives, for example, an antistatic agent such as sodium alkylsulfonate, sodium alkylsulfate, stearic monoglyceride, and polyether-ester amide; an antioxidant such as hindered phenol; a flame retardant such as phosphoric esters; a lubricant such as palmitic acid, and stearyl alcohol; a light stabilizer such as hindered amine; an oxidation inhibitor such as hindered phenol; a variety of dyestuffs; a fluorescent bleach; and ultraviolet absorbers such as benzotriazole-based ultraviolet absorbers, benzophenone-based ultraviolet absorbers, cyanoacrylate-based ultraviolet absorbers, malonic ester-based ultraviolet absorbers, oxalic anilide-based ultraviolet absorbers, and acetic acid ester-based ultraviolet absorbers may be added. These additives may be used alone or in combinations of two or more of them.

The light diffusing plate (1) according to the present invention may be manufactured by, for example, a profile extrusion method. For example, the light diffusing plate can be produced in a profile extrusion method such that a raw material resin containing a light diffusing agent is heated by an extrusion machine (such as a uniaxial extrusion machine and a biaxial extrusion machine), the resulting molten raw material resin is extruded from profile extrusion dies while melting and kneading, and is then cooled and solidified by sizing. In this production method, the profile extrusion dies have a lip having a desired profile has been provided is attached to the extrusion machine, whereby a predetermined shape having the hollow portions is formed inside a resin plate. The shaped resin is introduced into a sizing device (which is evacuated) immediately after being discharged from the dies, to obtain a light diffusing plate. In this method, a multilayered light diffusing plate can be formed using profile extrusion dies having a multilayered structure. Here, a “multilayered” light diffusing plate means that the light diffusing plate comprises surface layers and a main layer comprising a plate having hollow portions in which the surface layers and the main layer are made of a plurality of different resins. Namely, it is possible to obtain a light diffusing plate in which the upper and lower flat plates (2, 2) are formed from different resins; a light diffusing plate in which each of the upper and lower flat plates (2, 2) is formed in a multilayered structure using different kinds of resin; a light diffusing plate in which the upper and/or lower surface layers and the main layer having the hollow portions are formed from resins different from one another; and the like. In any case, the light diffusing plate can be produced so that the upper and lower flat plates (2, 2) and rib members (4) are simultaneously prepared so as to be unified.

On one hand, the light diffusing plate (1) shown in FIG. 3 can also be manufactured in such a manner that the upper and lower flat plates (2, 2) and rib members (4) are have been previously molded separately, and these molded parts are bonded to one another by means of an adhesive, thermal fusion or the like.

The light diffusing plate (1) according to the present invention may be used to be incorporated in a flat panel display device (6) as shown, for example, in FIG. 4. The flat panel display device (6) comprises an image displaying element (7), the light diffusing plate (1) arranged on the backside of the image displaying element, and a light source (9) arranged on the backside of the light diffusing plate (1) in which a lighting installation (8) is composed of the light diffusing plate (1) according to the present invention and the light source (9), the installation (8) being a so-called direct-type backlight. Incident light (Lᵢ) emitted from the light source (9) enters a surface of the backside of the light diffusing plate (1) according to the present invention, whereby the light is diffused during transmitting through the light diffusing plate (1). The light makes a diffusion transmission light (Lₒ) and is introduced to the image-displaying element (7) so that the image displaying element (7) is illuminated from the backside thereof. Examples of the image-displaying element (7) include a transmission liquid crystal display and the like. Examples of the light source (9) include a cold-cathode tube, an LED (light emitting diode) and the like. Since the flat panel display device (6) uses the light diffusing plate (1) according to the present invention, its weight is reduced as compared with the flat pane display that uses a conventional light diffusing plate. When the light diffusing plate (1) having a section as shown in FIG. 3 is applied, there is no need to provide a margin in response to an amount of camber (wrap), and a thinner flat panel display device can be achieved.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2004-278832 filed on Sep. 27, 2004, including specification, claims, drawings and summary, are incorporated herein by reference in their entirety.

### EXAMPLES

The present invention is described in more detail by following Examples, which should not be construed as a limitation upon the scope of the present invention.

Light diffusing plates obtained in Example and Comparative Example below are evaluated in accordance with the following manner.

(1) Water Absorption Camber (Wrap) Test:

A light diffusing plate to be evaluated was cut out to obtain a test piece thereof. The test piece was sandwiched between two steel flat plates and maintained at 90° C. for 5 hours in the air, while holding them in a horizontal level. The test piece is then allowed to cool for 24 hours to dry it. A sealing tape is applied to an edge portion of the test piece obtained after drying, whereby a condition in which invasion of water is prevented from the edge portion is maintained, and only either one surface of the test piece is immersed in pure water at room temperature (about 25° C.). After 24 hours, amounts of camber (wrap) at four corners of the test piece are measured, and an average value of them is indicated as an amount of camber (wrap) of the light diffusing plate.

In Example and Comparative Example below, a MA resin (which is a copolymer resin obtained by 96 parts by weight of methyl methacrylate and 4 parts by weight of methyl acrylate (refractive index: 1.49).

### Example 1

The MA resin was molten and kneaded, while heating in an extrusion machine (screw diameter: 40 mm, a uniaxial type, with a bent; manufactured by Tanabe Plastics Co., Ltd.). The resin thus molten and kneaded was transferred to profile extrusion dies having a lip portion where triangular profile structures had been aligned, to extrude the resin. The resulting product was cooled by sizing to obtain a light diffusing plate (1) having a structure shown in FIG. 3.

The light diffusing plate (1) has 20 cm width and 3 mm thickness (t₁), the flat plates (2, 2) constituting the light diffusing plate (1) have a thickness (t₂) of about 0.3 mm, respectively, and a spacing (tₛ) between both the flat plates (2, 2) is about 2.4 mm. Each thickness (t₄) of a plurality of the rib members (4) is about 0.3 mm. Each rib member (4) is placed at an angle (θ) of 60° with respect to each of the flat plates (2, 2). A proportion [S₂₄:S₅] of a total sectional area (S₂₄) of the flat plates (2, 2) and the rib members (4) of the light diffusing plate (1) with respect to a total sectional area (S₅) of internal hollow portions (5) is 1:1. After water absorption camber (wrap) test, the light diffusing plate (1) had a camber (wrap) of 1 mm.

### Comparative Example 1

A resin plate (thickness: 2 mm) of the MA resin, which had a solid structure, was obtained by an extrusion molding. The plate was comparatively heavy. After water absorption camber (wrap) test, the resin plate had a camber (wrap) was 3.5 mm.

What is claimed is:

1. A light diffusing plate having a plurality of hollow portions formed therein, the hollow portions extending in parallel with one another.

2. The light diffusing plate according to claim 1, wherein the hollow portion has a triangular or circular sectional shape.

3. The light diffusing plate of claim 1, wherein a ratio of the total sum of sectional areas of the hollow portions to the total sectional area (S₁) of the light diffusing plate including the hollow portion areas is 5% to 75%.

4. The light diffusing plate according to claim 1, which comprises:
a pair of flat plates arranged in parallel with each other with a space provided therebetween; and
a plurality of rib members that are arranged between the flat plates to couple the flat plates to each other, wherein
the rib members are placed at an angle of from 300 to 750 with respect to the flat plates,
the rib members make contact with the adjacent rib members on or in the vicinity of a line at which the former rib members make contact with the flat plates, and
the flat plate and the rib members constitute the hollow portions having triangular sectional shapes.

5. The light diffusing plate according to claim 1, which comprises at least one resin selected from the group consisting of a methyl methacrylate resin, a polystyrene resin, a methyl methacrylate-styrene resin, a polycarbonate resin, a resin containing an alicyclic structure-containing ethylenically unsaturated monomeric unit and a polyethylene terephthalate resin.

6. A flat panel display device comprising:
an image displaying element;
the light diffusing plate according to claim 1 or 2, which is arranged on a backside of the image displaying element; and
a light source arranged on a backside of the light diffusing plate, wherein
light emitted from the light source enters the light diffusing plate and is diffused during transmitting the light diffusing plate to be diffusion transmitted light, and the diffusion transmitted light is introduced to the image displaying element so as to illuminate the image displaying element from the backside thereof.
